(19) United States
(12) Patent Application Publication
(10) Pub. No.: US 2005/0231347 A1
(43) Pub. Date: Oct. 20, 2005

(54) Vehicle, visual signals for U-turn & decelerating

(76) Inventor: Steven Leo Company, Deerfield Beach, FL (US)

Correspondence Address: STEVEN LEO COMPANY, 3413 Tuscany Way, Boynton Beach, FL, 33435, US

(21) Appl. No.: 10/818,001

(22) Filed: Apr. 5, 2004

(51) Int. Cl. B60Q 1/50

(52) U.S. Cl. 340/464; 340/467; 340/465

(57) ABSTRACT

These vehicle signals [U-turn and Decelerating] are located infront of The vehicle so others drivers can have better information before they decide Any left or right turn that can produce an accident.

### BACKGROUND OF THE INVENTION

At intersections to prevent accidents as vehicles can turn left or turn right This device is done to inform others drivers before they make any wrong Decision that can result in an accident.

The device is located infront of the vehicle so that each signal is clear to see.

### SUMMARY OF THE INVENTION

According to the present invention the device with two visual signals is Located infront of the vehicle so the signals are clear to see for others drivers When a u-turn is going to be done this signal is activated indicating the others Drivers that a u-turn is going to be done, this way the driver at the intersection That was going to do a right turn must wait till the u-turn is done, this way Preventing an accident to occur.

When the vehicle is decelerating the second visual signal is activated indicating The others drivers that maybe the left turn he/she is going to do is possible This way preventing an accident at the intersection to occur.

### DETAILED DESCRIPTION

The device is located infront of the vehicle so at an intersection drivers Can see them clear when activated.

When a u-turn is going to be done the device will be activated by the Driver, this way informing the other driver at the intersection to wait for his Right turn until the u-turn is done.

The u-turn is a visual signal that is neccessary so the others drivers know That it is not a simple left turn.

When the vehicle is decelerating the second visual signal is activated so Any driver at a intersection can decide better if his left turn is possible, this way Preventing accidents.

This second visual signal is connected to the stop light, just that this one is Located infront of the vehicle.

The first visual signal is connected to the turning signals so they will flash at the Same frequency, once the u-turn is activated form the driver.

The color of the signals are red as the stop signals of the vehicle, this way the color Represent precaution for others drivers.

When a u-turn is going to be done the others drivers will notice the yellow turning Signal on and the u-turn signal also on, this way sending a visual signal of Precaution and indicating him to wait for his right turn till the u-turn is done.

1. An device for vehicles that has two visual signals and is located Infront of the vehicle.

2. An device according to claim 1, wherein the first visual signal is For U-turn.

3. An device according to claim 1, wherein the second visual signal is for Decelerating.

4. An device according to claim 2, wherein the visual signal informs other Drivers at an intersection from doing a right turn, this way preventing accidents.

5. An device according to claim 3, wherein the visual signal informs others Drivers at an intersection to go on with a left turn, this way preventing accidents.
